(19) United States
(12) Patent Application Publication
(10) Pub. No.: US 2026/0254541 A1
(43) Pub. Date: Aug. 27, 2026

(54) IMPLICIT SOUNDING AND DISTRIBUTED MULTIPLE INPUT MULTIPLE OUTPUT (D-MIMO) IN WIRELESS LOCAL AREA NETWORKS (WLANS)

(71) Applicant: Telefonaktiebolaget LM Ericsson (publ), Stockholm (SE)

(72) Inventors: Rocco DI TARANTO, Lund (SE); Dennis SUNDMAN, Sollentuna (SE); Joao VIEIRA, Hjärup (SE); Miguel LOPEZ, Solna (SE)

(21) Appl. No.: 18/992,419

(22) PCT Filed: Jul. 14, 2022
(86) PCT No.: PCT/EP2022/069748

§ 371 Date: Jan. 8, 2025

(51) Int. Cl. H04B 17/12; H04B 7/024

(52) U.S. Cl. CPC H04B 17/12; H04B 7/024

(57) ABSTRACT

A method, system and apparatus for implicit sounding and distributed multiple input multiple output in wireless local area networks are disclosed. According to one aspect, a method in a first network node includes receiving from a second network node, a phase alignment request, determining first phase information based at least in part on the received phase alignment request, selecting a first calibration coefficient, applying the first calibration coefficient to a first signal to be transmitted by the first network node to the WD, and transmitting to the second network node a phase alignment response to the phase alignment request, the phase alignment response including the first phase information and the first calibration coefficient, to enable the second network node to determine, a second calibration coefficient to be applied by the second network node when the second network node transmits a second signal to the WD.

### TECHNICAL FIELD

The present disclosure relates to wireless communications, and in particular, to implicit sounding and distributed multiple input multiple output (D-MIMO) in wireless local area networks (WLANs).

### BACKGROUND

The Institute of Electrical and Electronics Engineers (IEEE) has promulgated standards for Wireless Local Area Networks (WLANs), of which Wireless Fidelity (Wi-Fi) networks are a type. Such networks typically include a server providing Internet access to wireless access points (AP stations) which provide wireless communications with wireless devices (non-AP stations). In contrast, the Third Generation Partnership Project (3GPP) has developed and is developing standards for Fourth Generation (4G) (also referred to as Long Term Evolution (LTE)) and Fifth Generation (5G) (also referred to as New Radio (NR)) cellular wireless communication systems. Such systems typically include a central node, radio base stations and wireless devices.

D-MIMO with Explicit Sounding Protocol

Beginning in 2018, Broadcom has provided a detailed description of how a constrained distributed MU-MIMO (D-MU-MIMO) transmission scheme may operate in WLANs using building blocks available in the IEEE 802.11ax standard amendment (referred to as Wi-Fi 6). Distributed MU-MIMO means MU-MIMO running jointly on multiple distributed access points (APs). Constrained means that all participating APs are within a region of coverage of the APs, namely, the shared AP. For D-MIMO to work, the APs must be synchronized so that they can jointly transmit at the same time. Tight synchronization is needed because the signals arriving from different APs should add constructively at the receiver side. After phase-based synchronization, the phase misalignment between APs should be on the order of a few degrees, depending on the type of beamforming used. One problem is that the internal clocks (oscillators) in the APs drift independently, and even if they may synchronize at some point in time, that does not necessarily imply that the phase responses of different APs are aligned at the time of the joint transmission (JT).

Therefore, this drift needs to be corrected close to when the joint transmission starts. A configuration has been proposed where the shared AP sends several “trigger frames” to enable sharing APs to synchronize and re-synchronize their timing, carrier frequency offset (CFO) and phase. Sharing APs pre-compensate for the total phase drift (which also accounts for time-of-flights of the trigger frames, which may be different) and for the CFO offsets. After pre-compensation, the sharing APs join the shared AP in joint transmissions. FIG. 1 shows an example of operation of a protocol proposed by Broadcom. As can be seen in FIG. 1, the trigger frame is used to trigger each part of the process—null data packet (NDP) announcement, sounding, and for every joint MU-MIMO transmission thereafter. A benefit of transmitting the trigger frame before every joint transmission is threefold: a) it tells a sharing AP that this is going to be a joint transmission, b) it allows a sharing AP to calculate the phase rotation from one trigger frame to the next trigger frame, and c) it allows a sharing AP to calculate impact of new timing synchronization and apply a phase correction.

Referring to FIG. 1, before every joint transmission, the sharing AP (master AP) sends a trigger frame (TF) that is used first to synchronize the APs and then also to trigger the joint physical protocol data unit (PPDU) transmission. A TF also triggers the explicit channel sounding, i.e., a TF is also sent before the extremely high throughput (EHT) null data PPDU (NDP) used by the station (STA) to estimate the channel state information (CSI) between the two APs and itself. Note that since the TF is sent from the Sharing AP to the Shared APs, the consecutive PPDUs are not perfectly aligned, but are transmitted at slightly different times. Due to strict D-MIMO requirements on synchronization, the time of flight (ToF) of the trigger frame (TF) cannot be neglected. In this proposed configuration, there is no need to know the ToF. Instead, it suffices to have a precise estimation of the phase rotations measured by the STA on the downlink (DL) channels from AP1 and AP2. Although the EHT-NDP frames from AP1 and AP2 are slightly misaligned (AP2 sends its EHT-NPDToF after AP1), such misalignment is accounted for in the phase rotations the non-AP STA measures when it receives the two NDPs. Thus, it becomes part of the channel state information (CSI) at the STA. Then the STA feeds back this information on phase rotations (possibly including other information) to both APs, as shown in FIG. 1. Assuming the precise same ToF is used for the Joint PPDU transmission, this misalignment is compensated for by the precoder in the transmitters (through the received CSI from the STAs).

### TSF Timing Accuracy

STAs in a single basic server set (BSS) are synchronized to a common clock. A time synchronization function (TSF) keeps the times for all STAs in the same BSS synchronized. Subclause 11.1.3.9 (TSF Timing Accuracy) in IEEE Std 802.11-2020 states that the worst-case drift for two non-directional multigigabit (non-DMG) STAs is plus/minus 200 ppm (parts per million). Upon receiving a Beacon, the STAs update their TSF timer. The IEEE 802.11 STA clock rate is 1 MHz and 200 ppm errors implies that in each non-AP STA, one second could be 200 us too long or too short. In a worst case, one STA has 200 ticks too many in one second, the other STA has 200 ticks less in one second. In 100 ms (a typical beacon interval) the error would then be 20 ticks. So, a worst case error would be 20 us which is too big for D-MIMO to work. However, this error would occur if there were no transmission in between two beacons. This is not the case in Broadcom's study where clock drifts are repeatedly corrected with the help of the Slave TF. Using TSF to synchronize the clocks among APs is not sufficient to fulfill the requirements for JT.

### Transmit Center Frequency Tolerance and Symbol Clock Frequency Tolerance.

Subclause 19.3.18.4 “Transmit center frequency tolerance” and Subclause 19.3.18.6 “Symbol clock frequency tolerance” in IEEE Std 802.11-2020 provide maximum tolerances with respect to the operating radio frequency. The transmit center frequency tolerance tells how many Hertz a generated center frequency can deviate from the nominal center frequency. Similarly, there is a symbol clock frequency tolerance. The IEEE Std 802.11 provides:
Transmit center frequency tolerance. The transmit center frequency tolerance shall be plus/minus 20 ppm for the 5 GHz band and plus/minus 25 ppm for the 2.4 GHz. The different transmit chain center frequencies (local oscillators (LO)) and each transmit chain symbol clock frequency shall all be derived from the same reference oscillator; and
Symbol clock frequency tolerance. The symbol clock frequency tolerance shall be plus/minus 20 ppm for 5 GHz bands and plus/minus 25 ppm for 2.4 GHz bands. The transmit center frequency and the symbol clock frequency for all transmit antennas shall be derived from the same reference oscillator.

The transmit center frequency error (CFO) affects the frequency synchronization between the two copies of the signal to be transmitted by a first AP and second AP to the STA, while the symbol clock frequency error affects the time-length of the two copies of the signal. These two errors both induce a phase rotation of the received signal at the STA. In the Broadcom scheme mentioned above, it is the task of the Shared AP to compensate for the effects of these two errors before joining the Shared AP in the joint transmission to the STA. In practical cases with D-MIMO (where much better hardware than the minimum standard compliant requirement is used), it is possible to neglect the effects of the symbol clock frequency error and the STA needs only to correct the CFO error. In Wi-Fi, such correction is done first using L-STFs (short (legacy) training fields) and L-LTF (long training fields) (coarse and fine correction respectively for the whole packet) and then using the pilots in each data field, typically for a symbol-by-symbol further CFO correction. In the Broadcom scheme it is assumed that the CFO is estimated and compensated by the Shared AP each time a slave TF is received. For example, this occurs three times in FIG. 1.

Transmit Beamforming with Implicit Feedback in IEEE Std 802.11n-2009 (Later Deprecated)

For a beamformer to calculate an appropriate steering matrix for transmit spatial processing when transmitting to a specific beamformee, the beamformer needs to have an accurate estimate of the channel over which it is transmitting. With implicit feedback, the beamformer receives long training symbols transmitted by the beamformee, which allows the MIMO channel between the beamformee and the beamformer to be estimated. If the channel is reciprocal, the beamformer can use the training symbols that it receives from the beamformee to make a channel estimate suitable for computing the transmit steering matrix. Note that the physical channel itself is always reciprocal, however the TX and RX chains in the beamformer and beamformee are not.

IEEE Std 802.11n-2009 (HT, High Throughput) supports both explicit and implicit feedback. For simplicity of implementation and because implicit feedback was in practice never implemented in products, IEEE Std 802.11 ac-2013 (VHT, Very High Throughput) and IEEE Std 802.11 ax-2021 (HE, High Efficiency) support only explicit feedback. Subclause 9.19.2 “Transmit beamforming with implicit feedback” in IEEE Std 802.11n-2009 details the procedures for implicit beamforming. Recently whether implicit beamforming should be re-introduced at some point in WLANs, has been considered.

The main issue related to using implicit feedback for channel estimation is on the calibration requirement.

### Transmit/Receive (TX/RX) Calibration in WLANs

Differences between transmit and receive chains in a STA degrade the inherent reciprocity of the over-the-air time division duplex channel and cause degradation of the performance of implicit beamforming. Calibration acts to remove or reduce differences between transmit and receive chains and enforce reciprocity in the observed baseband-to-baseband channels between two STAs. Subclause 9.19.2.4, “Calibration”, in IEEE Std 802.11n-2009 provides some details on calibration between transmit and receive chains in WLAN STAs: such calibration methods make use of interactive sounding between the AP and the STA. However, the possibility and effectiveness of transmit side-calibration, where the sounding is done locally between the AP antennas only, has been considered.

Another option that has been considered is application of local AP calibration methods where the STA is not required to be involved in the calibration process. A limitation is that the channel estimation that can be obtained is not sufficiently accurate to enable D-MIMO transmissions. Yet another alternative is to let different chains in the same AP exchange calibration messages. For example, the AP may send a signal from transmit chain 1 to receive chain 2 first. And then send a reference signal from transmit chain 2 to receive chain 1. To perform this operation, a so-called simultaneous transmit and receive, STR, AP is needed. By sending the signal in this way, the AP would estimate the various delays in between these two chains.

### Beacon Transmission in Wi-Fi Networks

A Beacon frame is one of the management frames in IEEE 802.11 based WLANs. It contains all the information about the network. Beacons are transmitted periodically; they serve to announce the presence of a wireless LAN and to synchronize the members of the service set. Beacons are transmitted by an AP that serves a BSS. The body of the beacon includes the following fields (as well as other fields):
Timestamp: After receiving the beacon frame. all STAs change their local clock to this time. This helps with synchronization;
Beacon Interval: This is the time in between beacon transmissions. The time at which the AP must send a beacon is known as target beacon transmission time (TBTT). The Beacon interval is expressed in Time Units (TUs). TBTT is a configurable parameter in the AP and typically configured as 100 TUs.
Wi-Fi only supports explicit beamforming feedback (explicit sounding).
   This comes with one or more of the following limitations:
A large network overhead when APs have large number of antennas since each TX/RX antenna pair needs to be sounded independently;
In joint transmission (JT), the number of TX antennas becomes the sum of TX antennas of all participating APs. Thus, with explicit sounding, the sounding phase may become large;
The CSI information needs to be fed back to the APs, which implicates the impact of the quantization and compression typically used to reduce the amount of information to feedback: while sending less data reduces overhead, it may result in not sending enough information to the APs, especially when advanced multi-AP transmissions are to be used; and
Also, explicit sounding puts most of the computational burden on the STAs which may put constraints on STA hardware and increase STA power consumption.

Other aspects to be addressed include the channel aging and the large delays that may occur in between the channel estimation and the actual D-MIMO transmissions. Moreover, when the standard introduces new features, for example more spatial streams, all frames used for explicit beamforming need to be updated.

While Broadcom's proposal may be viable in enabling D-MIMO transmissions in WLANs, it still suffers from the fundamental limitations of explicit beamforming sounding.

Implicit sounding was defined in IEEE Std 802.11n-2009 but has since been deprecated.

### SUMMARY

Some embodiments advantageously provide methods, systems, and apparatuses for implicit sounding and distributed multiple input multiple output (D-MIMO) in wireless local area networks (WLANs).

Some embodiments include methods for enabling D-MIMO transmissions with implicit sounding in WLANs. To this end, one or more of the following challenges are addressed in some embodiments:
1. The APs need to align their TX chain phases;
2. The Shared APs need to compensate their TX phases based on the inherent misalignment caused by the TF; and/or
3. Protocol with sufficient detail is needed to address the challenges above and to incorporate legacy methods for (AP and non-AP) STA TX and RX calibration methods.

In some embodiments, methods include alignment of transmission phases among multiple APs through the application of independent calibration coefficients cᵢ. The calibration coefficients may be different for each subcarrier; and the calibration coefficients should be the same for all antennas at each AP.

In some embodiments, one or more of the following processes are performed: the calibration coefficients, cᵢ, are derived through an equation, where there is a relationship among multiple cᵢ's. A first calibration coefficient, c₁, may be selected randomly or arbitrarily or otherwise may be assumed known. The other cᵢ's are derived as a function of c₁. In particular, a specific c₂ may be derived as the subtraction between c₁ and a training phase. The training phase may include estimating a training sequence transmitted from an AP2 to AP1. The subtraction can be expressed as a fraction if the phases are expressed as complex exponentials. Information is obtained from the exchange of 2 frames. In the first frame a training sequence is transmitted from APN to AP1. The training sequence is used to estimate a training phase. The training sequence may for example be the LTF. In the second frame the estimate of the training phase is sent from AP1 to APN. The second frame may also contain the calibration coefficient c₁ selected by AP1.

According to a first aspect, a method in a first network node configured to communicate with a wireless device, WD, is provided. The method includes receiving from a second network node, a phase alignment request. The method also includes determining first phase information based at least in part on the received phase alignment request and selecting a first calibration coefficient. The method also includes applying the first calibration coefficient to a first signal to be transmitted by the first network node to the WD. The method further includes transmitting to the second network node a phase alignment response to the phase alignment request, the phase alignment response including the first phase information and the first calibration coefficient, to enable the second network node to determine, based at least in part on the first phase information and the first calibration coefficient, a second calibration coefficient to be applied by the second network node when the second network node transmits a second signal to the WD.

According to this aspect, in some embodiments, the first calibration coefficient calibrates a phase of the first signal relative to a phase of the second signal. In some embodiments, the first phase information is carried on a pilot signal from the second network node. In some embodiments, the method also includes scheduling phase alignment requests from a plurality of second network nodes. In some embodiments, the method also includes transmitting a phase alignment announcement to trigger the phase alignment request.

According to another aspect, a first network node configured to communicate with a wireless device, WD, is provided. The first network node includes a radio interface configured to receive from a second network node a phase alignment request. The first network node also includes processing circuitry in communication with the radio interface and configure to: determine first phase information based at least in part on the received phase alignment request; select a first calibration coefficient; apply the first calibration coefficient to a first signal to be transmitted by the first network node to the WD. The radio interface is further configured to transmit to the second network node a phase alignment response to the phase alignment request, the phase alignment response including the first phase information and the first calibration coefficient, to enable the second network node determine based at least in part on the first phase information and the first calibration coefficient, a second calibration coefficient to be applied by the second network node when the second network node transmits a second signal to the WD.

According to this aspect, in some embodiments, the first calibration coefficient calibrates a phase of the first signal relative to a phase of the second signal. In some embodiments, the first phase information is carried on a pilot signal from the second network node. In some embodiments, the processing circuitry is configured to schedule phase alignment requests from a plurality of second network nodes. In some embodiments, the radio interface is further configured to transmit a phase alignment announcement to trigger the phase alignment request.

According to yet another aspect, a method in a first network node configured to communicate with a wireless device, WD, is provided. The method includes receiving from a second network node a phase alignment response including first phase information and a first calibration coefficient; determining a second calibration coefficient based at least in part on the first phase information and the first calibration coefficient; and applying the second calibration coefficient to a first signal to be transmitted by the first network node to the WD.

According to this aspect, in some embodiments, determining the second calibration coefficient is based at least in part on determining a difference between the first calibration coefficient and the first phase information. In some embodiments, the second calibration coefficient calibrates a phase of the first signal relative to a phase of a second signal transmitted by the second network node to the WD. In some embodiments, the method includes transmitting a phase alignment request to the second network node, the phase alignment request including a pilot signal to carry the first phase information included in the phase alignment response. In some embodiments, transmitting the phase alignment request is responsive to a phase alignment announcement received from the second network node.

According to another aspect, a first network node configured to communicate with a wireless device, WD, is provided. The first network node includes a radio interface configured to receive from a second network node a phase alignment response including first phase information and a first calibration coefficient. The network node also includes processing circuitry in communication with the radio interface and configured to: determine a second calibration coefficient based at least in part on the first phase information and the first calibration coefficient; and apply the second calibration coefficient to a first signal to be transmitted by the first network node to the WD.

According to this aspect, in some embodiments, determining the second calibration coefficient is based at least in part on determining a difference between the first calibration coefficient and the first phase information. In some embodiments, the second calibration coefficient calibrates a phase of the first signal relative to a phase of a second signal transmitted by the second network node to the WD. In some embodiments, the radio interface is further configured to transmit a phase alignment request to the second network node, the phase alignment request including a pilot signal to carry the first phase information included in the phase alignment response. In some embodiments, transmitting the phase alignment request is responsive to a phase alignment announcement received from the second network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates operation of the Broadcom protocol;

FIG. 2 is a schematic diagram of an example network architecture illustrating a communication system connected via an intermediate network to a host computer according to the principles in the present disclosure;

FIG. 3 is a block diagram of a host computer communicating via a network node (AP) with a wireless device (non-AP station) over a wireless connection according to some embodiments of the present disclosure;

FIG. 4 is a flowchart of an example process in a first network node configured for implicit sounding and distributed multiple input multiple output (D-MIMO) in wireless local area networks (WLANs);

FIG. 5 is a flowchart of an example process in a second network node configured for implicit sounding and distributed multiple input multiple output (D-MIMO) in wireless local area networks (WLANs);

FIG. 6 is an illustration of an example configuration of stations including a first AP (AP1), a second AP (AP2) and a WD (STA3);

FIG. 7 is a first example of a protocol for implicit sounding according to a first embodiment disclosed herein;

FIG. 8 shows transmit and receive phases at AP1 and AP2;

FIG. 9 shows phase changes applied during transmission of a signal from a first station (STA1) to a second station (STA2);

FIG. 10 shows phase changes applied during transmission of a signal from AP2 to AP1;

FIG. 11 shows phase changes applied during transmission of a signal from AP1 to AP2;

FIG. 12 shows phase changes applied during transmission of a signal from a station (STA3) to AP1;

FIG. 13 shows phase changes applied during transmission of a signal from STA3 to AP2;

FIG. 14 shows application of a first precoder and first calibration coefficient by AP1 to a signal transmitted to STA3;

FIG. 15 shows application of a second precoder and second calibration coefficient by AP2 to a signal transmitted to STA3;

FIG. 16 is a second example of a protocol for implicit sounding according to a first embodiment disclosed herein;

FIG. 17 is a third example of a protocol for implicit sounding according to a first embodiment disclosed herein; and

FIG. 18 is fourth example of a protocol for implicit sounding according to a first embodiment disclosed herein.

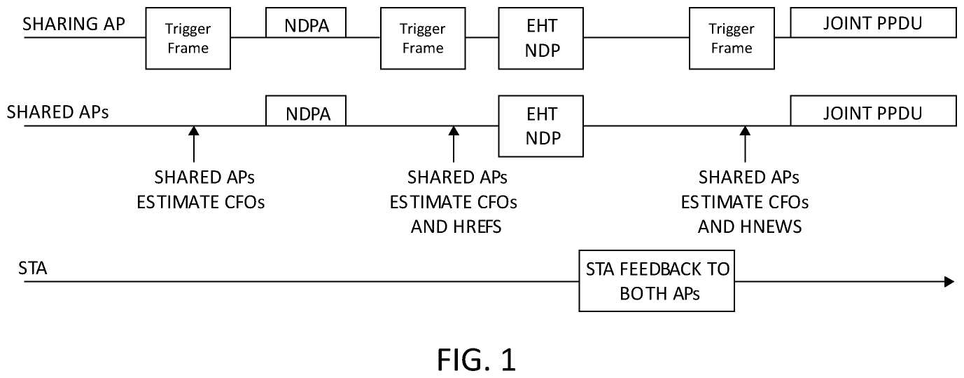

### DETAILED DESCRIPTION

Before describing in detail example embodiments, it is noted that the embodiments reside primarily in combinations of apparatus components and processing steps related to implicit sounding and distributed multiple input multiple output (D-MIMO) in wireless local area networks (WLANs). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise an access point (AP) in a wireless local area network (WLAN) or Wi-Fi network, and may be referred to as, or share hardware and infrastructure with, a base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc.

Thus, although many example embodiments described herein refer to WLAN and IEEE standards-compliant AP stations and non-AP stations, principles and features disclosed herein may be applied in 3GPP networks operating in an unlicensed spectrum., in the context of enabling joint transmissions from multiple transmission/reception points (TRPs) to one or more WDs, the TRP would be the equivalent of an AP station, and the WD would be the equivalent of a non-AP station.

In some embodiments, the non-limiting term wireless device (WD) is used herein to include a non-AP station (STA) in a WLAN network or in a Wi-Fi network. The WD herein can be any type of wireless device capable of communicating with a network node, such as an AP STA, or another WD (non-AP STA). The WD may also be a radio communication device, target device, device to device (D2D) WD, machine type WD or WD capable of machine to machine communication (M2M), low-cost and/or low-complexity WD, a sensor equipped with WD, tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

In some embodiments, the term station (STA) may refer to a non-AP station and/or an AP station.

Note that although terminology from one particular wireless system, such as, for example, WLAN, Wi-Fi, 3GPP LTE and/or New Radio (NR), may be used in this disclosure, this should not be seen as limiting the scope of the disclosure to only the aforementioned systems. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide implicit sounding and distributed multiple input multiple output (D-MIMO) in wireless networks, such as wireless local area networks (WLANs).

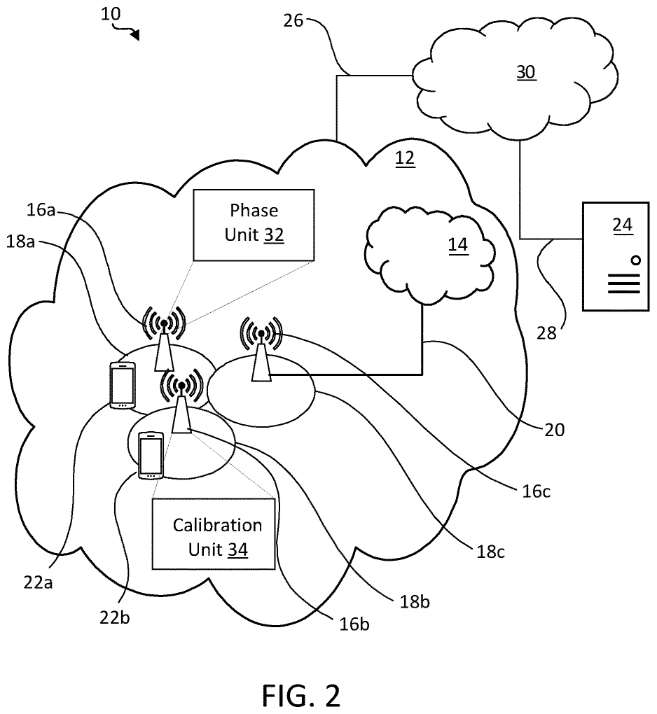

Referring again to the drawing figures, in which like elements are referred to by like reference numerals, there is shown in FIG. 2 a schematic diagram of a communication system 10, according to an embodiment, such as a WLAN network that supports Wi-Fi and/or a network that supports other standards such as Bluetooth, LTE and/or NR (5G). The communication system 10 includes an access network 12, such as a radio access network, and a core network 14. The access network 12 comprises a plurality of network nodes (also referred to herein as AP stations or APs) 16a, 16b, 16c referred to collectively as network nodes 16, or access points 16. Each access point 16 has antenna directivity to cover a corresponding coverage area 18a, 18b, 18c (referred to collectively as coverage areas 18). Each network node 16a, 16b, 16c is connectable to the core network 14 over a wired or wireless connection 20. A first wireless device (WD) (non-AP station) 22a located in coverage area 18a is configured to wirelessly connect to, or be paged by, the corresponding network node 16a. A second WD 22b (non-AP station) in coverage area 18b is wirelessly connectable to the corresponding network node 16b. While a plurality of WDs 22a, 22b (collectively referred to as wireless devices 22, or non-AP stations 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports cellular communications in an LTE or NR network, for example, and that supports WLAN communications as well.

The communication system 10 may itself be connected to a host computer 24 (also referred to herein as a server 24), which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, may be a backbone network or the Internet. In some embodiments, the intermediate network 30 may comprise two or more sub-networks (not shown). Thus, in some embodiments, the server or host computer 24 is a server at a location distant from an AP or network node 16 and be connected to the network nodes 16 via the Internet, either directly or indirectly.

The communication system of FIG. 2 as a whole enables connectivity between one of the connected WDs 22a, 22b and the host computer 24. The host computer 24 and the connected WDs 22a, 22b are configured to communicate data and/or signaling using the access network 12, the core network 14, intermediate network 30 and possible further infrastructure (not shown) as intermediaries.

A network node 16 is configured to include at least one of a phase unit 32 and a calibration unit 34. The phase unit 32 is configured to determine first phase information based at least in part on a received phase alignment request from a shared AP. The calibration unit 32 is configured to determine a second calibration coefficient based at least in part on the first phase information and a first calibration coefficient received from a sharing AP.

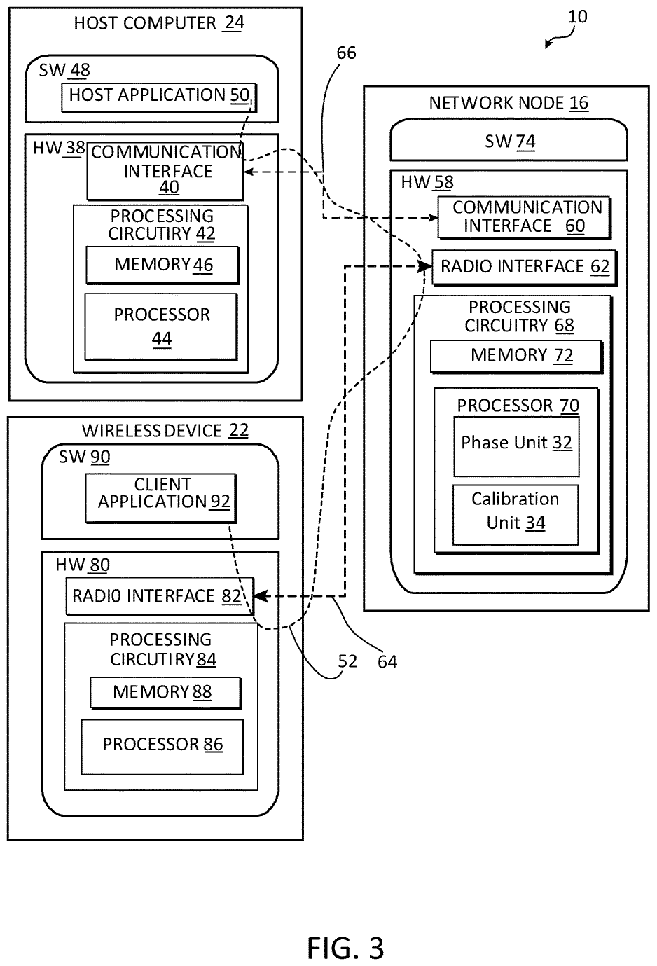

Example implementations of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via a connection 52 terminating at the WD 22 and the host computer 24. In providing the service to the remote user, the host application 50 may provide user data which is transmitted using the connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The network node (AP) 16 provided in communication system 10 includes hardware 58 enabling it to communicate with the host computer (server) 24 and with the WD (non-AP station) 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 is also configured to communicate wirelessly with other network nodes (access points) 16. The radio interface 62 may be formed as or may include, for example, one or more RF transmitters, one or more RF receivers, and/or one or more RF transceivers. In particular, the radio interface 62 will typically include multiple antennas that may be configured in a phased array including one or more arrays of antenna elements. For each frequency of transmission or reception, there are fixed electrical phase relationships between the antenna elements so that all such phases relationships may be referenced to one antenna element of the phased array.

The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include at least one of a phase unit 32 and a calibration unit 34. The phase unit 32 is configured to determine first phase information based at least in part on a received phase alignment request from the shared AP. The calibration unit 32 is configured to determine a second calibration coefficient based at least in part on the first phase information and a first calibration coefficient from the sharing AP.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers. In particular, the radio interface 82 may include multiple antennas that may be configured in a phased antenna array including one or more arrays of antenna elements.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the connection 52 terminating at the WD 22 and the host computer 24. In providing the service to the user, the client application 92 may receive request data from the host application 50 and provide user data in response to the request data. The connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 3 and independently, the surrounding network topology may be that of FIG. 2.

The wireless connection 64 between the WD 22 and the network node 16 is in accordance with the teachings of the embodiments described throughout this disclosure. One or more of the various embodiments improve the performance of services provided to the WD 22. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as phase unit 32, and calibration unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

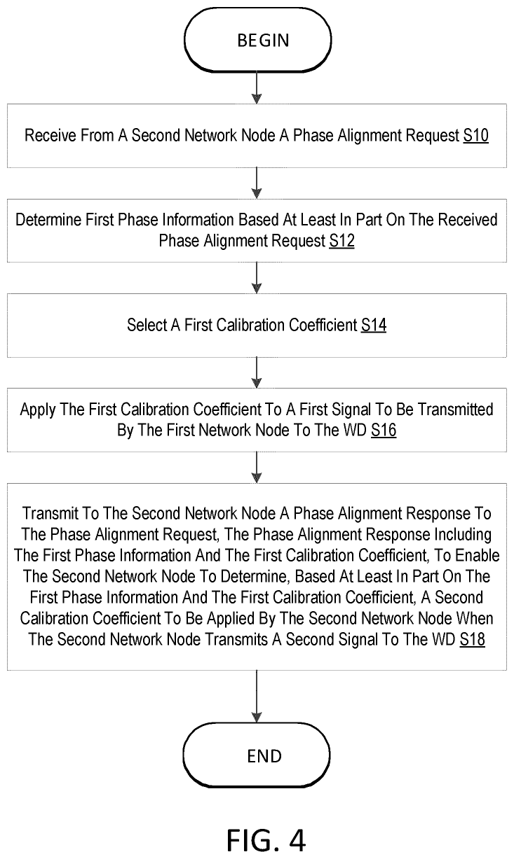

FIG. 4 is a flowchart of an example process in a network node 16a for implicit sounding and distributed multiple input multiple output (D-MIMO) in wireless local area networks (WLANs). One or more blocks described herein may be performed by one or more elements of network node 16a such as by one or more of processing circuitry 68 (including the phase unit 32), processor 70, radio interface 62 and/or communication interface 60. Network node 16a such as via processing circuitry 68 and/or processor 70 and/or radio interface 62 and/or communication interface 60 is configured to receive from a second network node 16b a phase alignment request (Block S10). The process includes determining first phase information based at least in part on the received phase alignment request (Block S12) and selecting a first calibration coefficient (Block S14). The process also includes applying the first calibration coefficient to a first signal to be transmitted by the first network node 16a to the WD 22 (Block S16). The process further includes transmitting to the second network node 16b a phase alignment response to the phase alignment request, the phase alignment response including the first phase information and the first calibration coefficient, to enable the second network node 16b to determine, based at least in part on the first phase information and the first calibration coefficient, a second calibration coefficient to be applied by the second network node 16b when the second network node 16b transmits a second signal to the WD 22 (Block S18). In some embodiments, the first calibration coefficient calibrates a phase of the first signal relative to a phase of the second signal. In some embodiments, the first phase information is carried on a pilot signal from the second network node 16b. In some embodiments, the method also includes scheduling phase alignment requests from a plurality of second network nodes 16. In some embodiments, the method also includes transmitting a phase alignment announcement to trigger the phase alignment request.

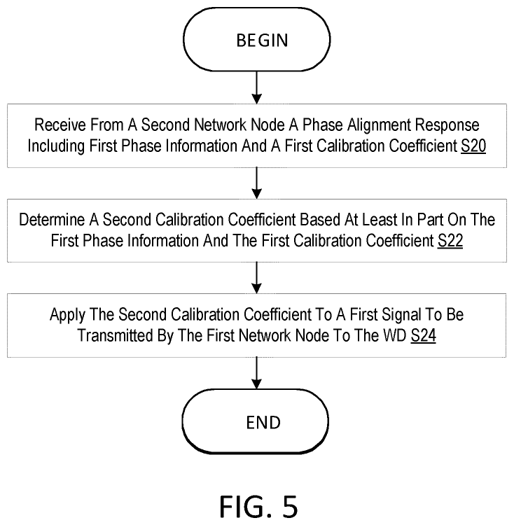

FIG. 5 is a flowchart of an example process in a network node 16b according to some embodiments of the present disclosure implicit sounding and distributed multiple input multiple output (D-MIMO) in wireless local area networks (WLANs). One or more blocks described herein may be performed by one or more elements of network node 16b such as by one or more of processing circuitry 68 (including the calibration unit 34), processor 70, radio interface 62 and/or communication interface 60. Network node 16b such as via processing circuitry 68 and/or processor 70 and/or radio interface 62 and/or communication interface 60 is configured to receive from a second network node 16a a phase alignment response including first phase information and a first calibration coefficient (Block S20). The process includes determining a second calibration coefficient based at least in part on the first phase information and the first calibration coefficient (Block S22). The process also includes applying the second calibration coefficient to a first signal to be transmitted by the first network node 16b to the WD 22 (Block S24).

In some embodiments, determining the second calibration coefficient is based at least in part on determining a difference between the first calibration coefficient and the first phase information. In some embodiments, the second calibration coefficient calibrates a phase of the first signal relative to a phase of a second signal transmitted by the second network node 16a to the WD 22. In some embodiments, the method further includes transmitting a phase alignment request to the second network node 16a, the phase alignment request including a pilot signal to carry the first phase information included in the phase alignment response. In some embodiments, transmitting the phase alignment request is responsive to a phase alignment announcement received from the second network node 16a.

Having described the general process flow of arrangements of the disclosure and having provided examples of hardware and software arrangements for implementing the processes and functions of the disclosure, the sections below provide details and examples of arrangements for implicit sounding and distributed multiple input multiple output (D-MIMO) in wireless local area networks (WLANs).

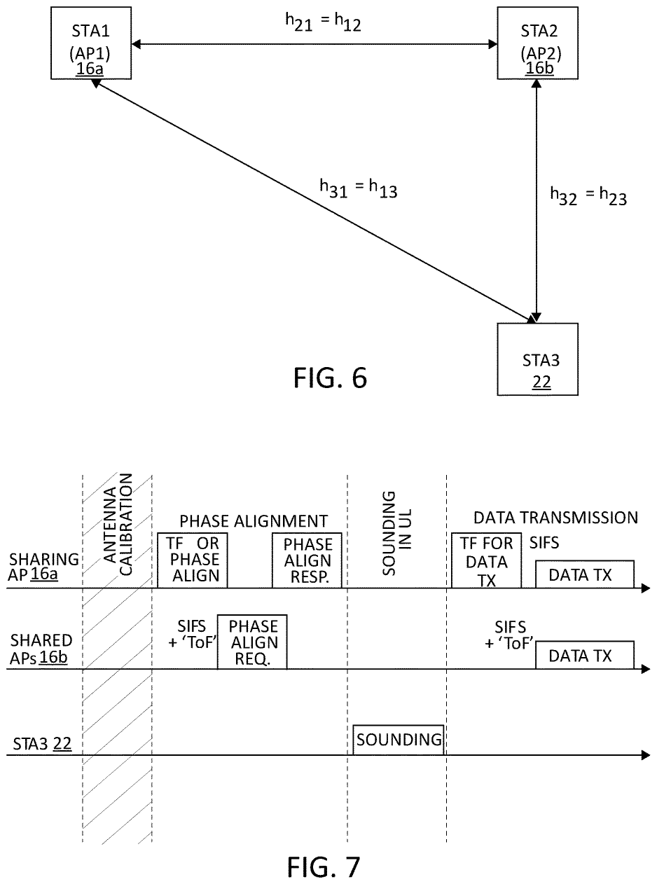

A configuration to which some embodiments are applicable is shown in the example of FIG. 6 where two AP STAs, STA 1 16a (hereinafter referred to as AP1) and STA 2 16b (hereinafter referred to as AP2), transmit to a non-AP STA, STA3 22 (hereinafter referred to as a WD 22 or STA3 22), using a Distributed SU-MIMO transmission. The methods described herein for a single user (SU) D-MIMO transmission are equally applicable to multi-user (MU) D-MIMO transmissions involving more than two AP stations. The two AP STAs may be equipped with multiple antennas.

Using D-MIMO transmission, decoding at STA3 22 requires that the two incoming signals from AP1 and AP2 arrive at STA3 22 with similar phases. Then, the signals add constructively. The two APs, AP1 and AP2, are connected over-the-air (OTA), (unlike typical 3GPP D-MIMO networks where measurements between different base stations are gathered at a central CPU via wired fronthaul/backhaul). FIG. 7 shows one example of a protocol for implicit sounding according to method disclosed herein. As can be seen in FIG. 7, the synchronization is done wirelessly by exchanging several frames in various parts (note that the various parts need not necessarily repeat in the order shown in FIG. 7).

FIG. 7 shows four parts to implicit sounding:
Part 1. Antenna Calibration. This part refers to the internal calibration among the antennas within each AP 16;
Part 2. Phase alignment. The outcome of the phase alignment is for each participating AP i to obtain a phase calibration coefficient cᵢ that will be applied to all its transceiver chains in the Data Transmission part 4. The three frames may serve at least one of the following purposes:
   TF for phase alignment: To initiate the phase alignment procedure. This frame is not used by the algorithm to obtain the calibration coefficients;
   Phase alignment request: Send a training signal t₀ from Shared AP 16b to Sharing AP 16a.
   Phase align response.: The Sharing AP 16a sends:
      Optionally: the phase cᵢ that is used by AP 16a; and
      the phase estimation based on the training signal from the Shared AP 16b;
Part 3. Sounding in uplink (UL). Exploiting reciprocity of the channel, AP1 16a and AP2 16b may choose their respective precoders based on sounding frames transmitted by STA3; and/or
Part 4. Data Transmission. Here, each AP i applies the calibration constant cᵢ derived in Part 2 in addition to other constants (e.g., the precoder).

Procedures and algorithms involved in Part 2 (Phase alignment) to obtain the cᵢ's are explained below, and it is shown how these calibration coefficients are used together with the precoder in the data transmission phase.

### Phase Alignment for the APs to Enable Coherent Transmissions

In Part 2 (Phase Alignment), the participating APs 16 exchange three frames to align their transmission phases, enabling coherent transmission in the Data Transmission Part 4. There may include one or more of the following three sources of misalignment of the RX phase in the intended receiver:
Part 2A. Different clocks in the APs 16, giving an unknown absolute phase for each transmission from the AP 16;
Part 2B. Different and unknown transmit and receiver chain delays giving rise to additional unknown phases; and/or
Part 2C. The Shared AP 16 triggers the Sharing APs 16 with a TF. Since the time it takes for the TF to reach the Sharing AP 16 is unknown, the different start-times of the joint data transmission are unknown, which in turns provides an unknown relative phase between the APs 16.

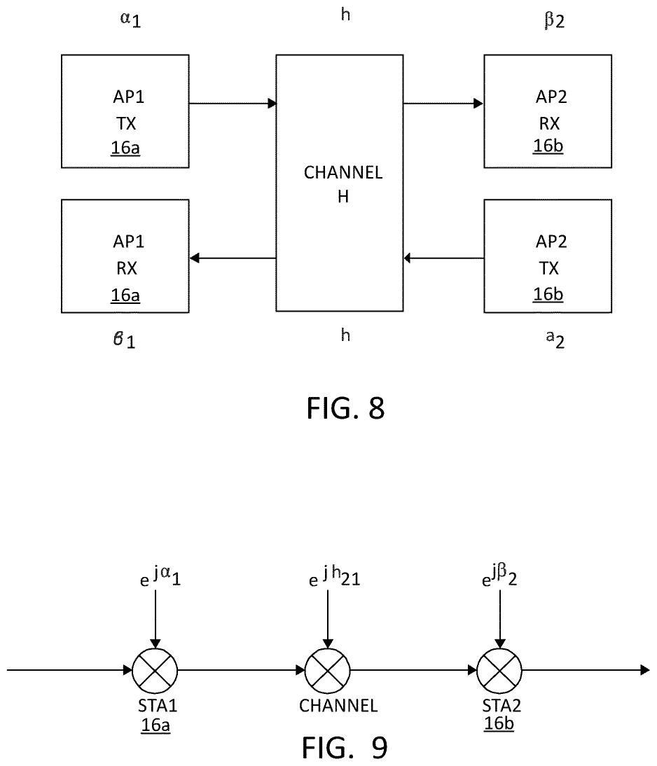

Some embodiments disclosed herein estimate the phases explained in Parts 2A, 2B, and 2C above. Consider the phase-based model shown in FIG. 8. Each STA i has a TX phase αᵢ and a RX phase βᵢ. These phases arise at least from different electronics in the Tx and Rx chains such as power amplifiers in the TX chain versus low noise amplifier in the RX chain, etc. Note that there are also different amplitudes because of different attenuations and amplifications. Therefore, the phase-based model can readily be extended to include amplitude. However, for clarity, variations in amplitude are suppressed. since phase may have more impact on coherent joint transmissions than amplitude. Typically, each antenna element of each transceiver has its own α and β, but since the TX chains are calibrated in the AP 16 in Part 1 (antenna calibration phase), each AP 16 can align its internal TX chains for the transmission to the STA3 22. However, different APs 16 have a different absolute clock reference. Thus, two APs 16 cannot align their transmissions. The different absolute references arise from the fact that the APs 16 have independent clocks that are not aligned.

Note the following observations regarding the αᵢ and βᵢ in this model:
Observation 1. Each AP i has only one αᵢ and one βᵢ that are applied to all antenna ports. In Part 1 (antenna calibration phase), internal synchronization among the different antenna ports is performed. Through that part, the relative phases between antenna ports are known. Therefore, it suffices in Part 2 (phase alignment) to consider a single unknown phase;
Observation 2. The responses αᵢ and βᵢ model the unknown transmit and receive phases. Furthermore, the responses αᵢ and βᵢ also account for effects of different electronics in the Tx and Rx radio frequency (RF) circuits, which have different responses. Thus, in general αᵢ≠βᵢ;
Observation 3. In the following discussion, phase drifts are neglected to focus the discussion on absolute phase alignment. This means that each AP 16 has a different understanding of the absolute phase (time) but their clocks run at the same pace (which can be achieved with an additional carrier offset synchronization step); and/or
Observation 4. All exchanges of phase may be performed using only a single antenna in all APs (due to Observation 1).

Although the α's and β's are the same for all antennas, they are in general different for each subcarrier (since each subcarrier has a different frequency). Each subcarrier will thus be subject to phase changes according to FIG. 9.

If subcarriers are neighbors to each other (e.g., only 15 KHz apart) then the α and β at one subcarrier are very close to the corresponding the α and β at a neighboring subcarrier, and in some cases it may be assumed that they are the same for a number of neighboring subcarriers. How fast the α and β vary across frequency depends on the frequency selectivity of the hardware response. Since generally Wi-Fi hardware is not expensive, different α and β on each subcarrier may be assumed in some embodiments.

Before explaining the protocol, note the following about reference clocks. AP1 16a and AP2 16b have different oscillators, which for means they understand phases differently. This is analogous to having a different understanding of time, such that 12:00 AM for AP1 16a may be the same as 12:01 AM for AP2 16b. This may be modelled as follows. A phase 0 for AP1 16a corresponds to a phase γ for AP2 16a. The reference AP1 in a signal s may be represented as s^{APi}, for example: s^{AP1}=s would be represented in AP2's reference clock as s^{AP2}=se^{jγ}. This phase offset can be modeled as part of the α's and β's introduced above. However, for clarity γ is shown explicitly in the following description.

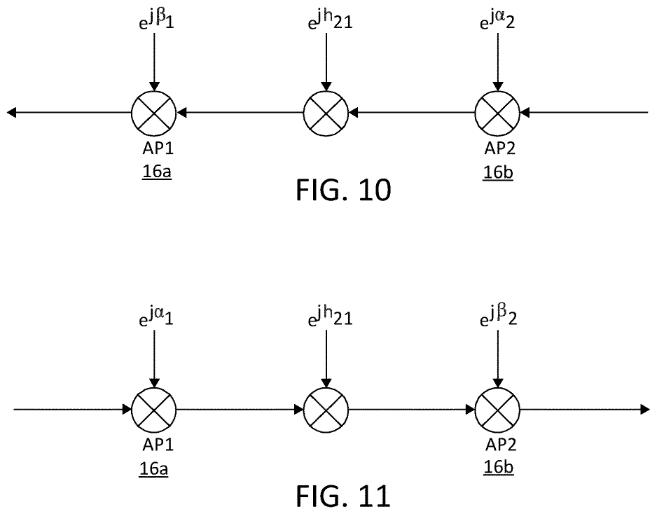

Referring back to FIG. 7, how AP1 16a and AP2 16b create their phase coefficients c₁ and c₂ in the phase alignment stage (Part 2), that are used in the Data Transmission stage (Part 3), is now explained:
A. The phase alignment announcement (or, phase alignment TF) is sent from the Sharing AP to the Shared APs. In this example, the Sharing AP is AP1 16a and there is only one Shared AP, AP2 16b. The methods described herein may be extended to more than one shared AP 16. The phase alignment announcement could be part of another frame in for example the transmission opportunity (TXOP) sharing protocol;
B. The Phase alignment request is sent from AP2 16b to AP1 16a. See FIG. 10. The Phase alignment request includes a pilot t₀ (for example the LTF):
   a. AP2 16b generates a pilot with phase

$${t}_{1}^{AP 2} = {t}_{0}$$

which is

$${t}_{1}^{AP 1} = {t}_{0} {e}^{- j γ} .$$

Note that AP2 16b will send this t₁ short interframe space (SIFS) after reception of the phase alignment announcement. If multiple Shared APs 16b, 16c are involved, they will be scheduled by the Sharing AP 16a accordingly. Since AP1 16a can estimate the phase offset from rotation of a pilot symbol during this SIFS time, it can compensate for it;
b. AP1 16a receives

$${r}_{1}^{AP 1} = {t}_{0} {e}^{j ( {α}_{2} + {h}_{21} + {β}_{1} - γ )}$$

and extracts the phase e^{j(α}^{₂}^{h}^{₂₁}^{+β}^{₁}^{-γ)};
C. AP1 16a selects a constant for itself, for example c₁=0. AP1 16a sends the phase alignment response containing the phase e^{j(α}^{₂}^{h}^{₂₁}^{+β}^{₁}^{-γ)} and c₁ to AP2 16b; AP2 16b receives e^{j(α}^{₂}^{h}^{₂₁}^{+β}^{₁}^{-γ)} and c₁ in a PPDU from AP1 16a (see FIG. 11);
D. AP2 16b can now derive:

$${e}^{{jc}_{2}} = \frac{{e}^{{jc}_{1}}}{{e}^{j ( {α}_{2} + {h}_{21} + {β}_{1} - γ )}} = {e}^{j ( γ - ( {α}_{2} + {h}_{21} + {β}_{1} ) )} .$$

When the phases between two APs are aligned as described above, the transmission becomes coherent at the receiver STA3 22, for example, by considering the effect of the sounding and the data transmission.

Through UL sounding (Part 3), AP1 16a and AP2 16b learn phase information from the STA3 22 through the following steps:
Step 1: Assume STA3 22 sends the signal t₀ in phase with AP1 16a (there can be an additional unknown phase for STA3 22, but it would not change anything). That is,

$${t}_{0}^{AP 1} = {t}_{0} and {t}_{0}^{AP 2} = {t}_{0} {e}^{j γ} ,$$

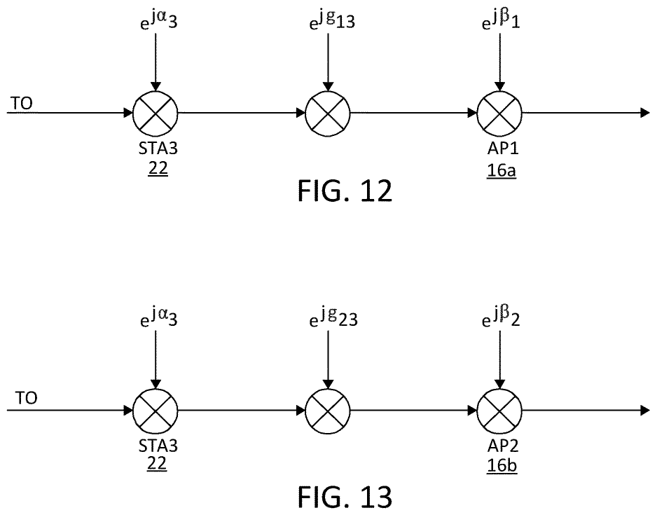

through the channel to AP1 16a (See FIG. 12);
1a) AP1 16a receives the sounding signal

$${s}_{1}^{AP 1} = {t}_{0} {e}^{j ( {α}_{3} + {g}_{13} + {β}_{1} )} ;$$

Step 2. The same signal is received in AP2 16b through the following channel (See FIG. 13):
   2a) AP2 16b receives the sounding signal

$${s}_{2}^{AP 1} = {t}_{0} {e}^{j ( {α}_{3} + {g}_{23} + {β}_{2} + γ )} ,$$

where γ appears because of consideration from AP1's perspective.

AP1 16a learns the phase information α₃+h₁₃+β₁ from the STA3 22. It can use this to form the precoder with phase p₁=−(α₃+h₁₃+β₁), also known as Matched Filter (MF) precoding. Similarly, AP2 16b forms its precoder p₂=−(α₃+h₂₃+β₂+γ), where γ appears because of consideration of the phases from AP1's clock. Note that only one antenna is considered in each AP 16. But the same holds for each antenna, except that separate of the impact of clock-phase and other phase impacts in α and β may be performed.

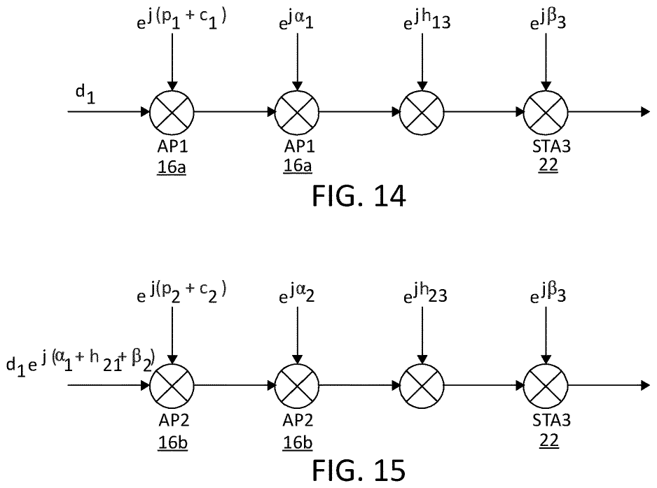

In the Data TX phase (Part 4), AP1 16a digitally applies its precoder p₁=−(α₃+h₁₃+β₁) and phase constant c₁ equal to zero, shown in FIG. 14.

Similarly, AP2 16b applies p₂=−(α₃+h₂₃+β₂+γ) and c₂=γ−(α₂+h₂₁+β₁), shown in FIG. 15. Since AP2 16b starts its transmission after a trigger frame, there are two logical phases at which it can start to transmit: with the received phase of the trigger signal, that is e^{j(α}^{₂}^{h}^{₂₁}^{+β}^{₁}^{-γ)} (using AP1's reference), or it can transmit at AP2's 0 phase, which is e^{-jγ} (again using AP1's reference). The former phase may therefore be selected, which is shown in FIG. 15.

The STA3 22 will receive the superposition r₃₁ and r₃₂ from AP1 16a and AP2 16b, respectively. Then:

$$\begin{matrix}{r}_{31}^{AP 1} = {d}_{1} {e}^{j ( {p}_{1} + {c}_{1} + {α}_{1} + {h}_{13} + {β}_{3} )} = {d}_{1} {e}^{j ( - ( {α}_{3} + {h}_{13} + {β}_{1} ) + 0 + {α}_{1} + {h}_{13} + {β}_{3} )} \\ = {d}_{1} {e}^{j ( - {α}_{3} - {β}_{1} + {α}_{1} + {β}_{3} )} ,\end{matrix}$$

$$and$$

$$\begin{matrix}{r}_{32}^{AP 1} = {d}_{1} {e}^{j ( {α}_{1} + {h}_{21} + {β}_{2} )} {e}^{j ( {p}_{2} + {c}_{2} + {α}_{2} + {h}_{23} + {β}_{3} )} \\ = {d}_{1} {e}^{j ( {α}_{1} + {h}_{21} + {β}_{2} )} {e}^{j ( - ( {α}_{3} + {h}_{23} + {β}_{2} + γ ) + γ - ( {α}_{2} + {h}_{21} + {β}_{1} ) + {α}_{2} + {h}_{23} + {β}_{3} )} \\ = {d}_{1} {e}^{j ( {α}_{1} - {α}_{3} + {β}_{3} - {β}_{1} )} .\end{matrix}$$

From this result it can be concluded that the signals from AP1 16a and AP2 16b add up coherently at the STA3 22.

### Protocol Embodiment 2

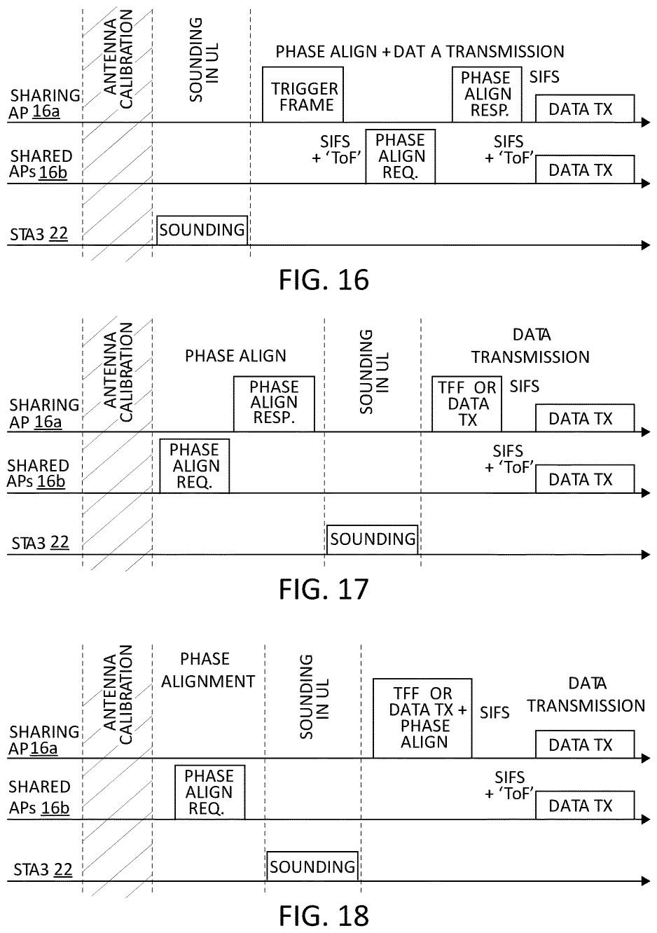

An another example protocol is shown in FIG. 16. In this protocol, the Phase alignment part (Part 2) has moved into the Data Transmission part (Part 4). Therefore, only one trigger frame (which contains the information in the phase alignment announcement frame) is needed.

### Protocol Embodiment 3

Another example protocol is shown in FIG. 17, where the Trigger Frame for phase alignment (Part 2) is not strictly employed to obtain the calibration coefficients. If the schedule for which Shared APs should send the Phase alignment request frames is known by other means (for example by using other frame exchanges), this protocol may also be employed.

### Protocol Embodiment 4

In yet another example protocol, the Phase alignment response frame may be included in the TF for Data TX. In FIG. 18, the phase alignment announcement is not present either, but it can be there.

### Phase Drift

If the channel between AP1 16a and AP2 16b during the first and the second TF transmission in FIG. 7 changes, AP2 16b measures different phase rotations. The different phase rotations may also arise because the two clocks continue to drift even in between the two TF transmissions. In this case, the Shared AP 16b may compensate for the further rotation before joining the master or sharing AP 16a in the D-MIMO transmissions. Furthermore, there are other frames that can be used to compensate for phase drifts, for example, by reading the beacons from the APs 16.

### Multiple Shared APs

When multiple Shared APs are part of the transmission, each of them may derive calibration coefficients as described above. For this to work efficiently, the “TF for phase alignment frame” may contain a schedule for the Shared APs.

### Channels

Since the phase alignment request frame provides the phase training used to compensate for the phase shift induced in the trigger frame for the data, the phase alignment request and data trigger frame may be sent over the same channel in some embodiments.

### Note on Subcarriers

In some embodiments, there may be a calibration coefficient for each subcarrier. In some embodiments, there may be fewer calibrations coefficients than subcarriers. For example, a single calibration coefficient may be determined as an average of at least two calibration coefficients.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AP | Access Point |
| BSS | Basic Service Set |
| CFO | Carrier Frequency Offset |
| D-MIMO | Distributed MIMO |
| JT | Joint Transmission |
| LNA | Low Noise Amplifier |
| MIMO | Multiple Input Multiple Output |
| LO | Local Oscillator |
| OTA | Over the Air |
| PA | Power Amplifier |
| PPDU | Physical Protocol Data Unit |
| SIFS | Short Inter Frame Space |
| STA | Station |
| STR | Simultaneous Transmit and Receive |
| TBTT | Target Beacon Transmit Time |
| TF | Trigger Frame |
| ToF | Time-of-Flight |
| TU | Time Unit |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a first network node configured to communicate with a wireless device, WD, the method comprising:
receiving from a second network node, a phase alignment request;
determining first phase information based at least in part on the received phase alignment request;
selecting a first calibration coefficient;
applying the first calibration coefficient to a first signal to be transmitted by the first network node to the WD; and
transmitting to the second network node a phase alignment response to the phase alignment request, the phase alignment response including the first phase information and the first calibration coefficient, to enable the second network node to determine, based at least in part on the first phase information and the first calibration coefficient, a second calibration coefficient to be applied by the second network node when the second network node transmits a second signal to the WD.

2. The method of claim 1, wherein the first calibration coefficient calibrates a phase of the first signal relative to a phase of the second signal.

3. The method of claim 1, wherein the first phase information is carried on a pilot signal from the second network node.

4. The method of claim 1, further comprising scheduling phase alignment requests from a plurality of second network nodes.

5. The method of claim 1, further comprising transmitting a phase alignment announcement to trigger the phase alignment request.

6. A first network node configured to communicate with a wireless device, WD, the first network node comprising:
a radio interface configured to receive from a second network node a phase alignment request; and
processing circuitry in communication with the radio interface and configure to:
determine first phase information based at least in part on the received phase alignment request;
select a first calibration coefficient;
apply the first calibration coefficient to a first signal to be transmitted by the first network node to the WD; and
the radio interface being further configured to transmit to the second network node a phase alignment response to the phase alignment request, the phase alignment response including the first phase information and the first calibration coefficient, to enable the second network node determine based at least in part on the first phase information and the first calibration coefficient, a second calibration coefficient to be applied by the second network node when the second network node transmits a second signal to the WD.

7. The first network node of claim 6, wherein the first calibration coefficient calibrates a phase of the first signal relative to a phase of the second signal.

8. The first network node of claim 6, wherein the first phase information is carried on a pilot signal from the second network node.

9. The first network node of claim 6, wherein the processing circuitry is configured to schedule phase alignment requests from a plurality of second network nodes.

10. The first network node of claim 6, wherein the radio interface is further configured to transmit a phase alignment announcement to trigger the phase alignment request.

11. A method in a first network node configured to communicate with a wireless device, WD, the method comprising:
receiving from a second network node a phase alignment response including first phase information and a first calibration coefficient;
determining a second calibration coefficient based at least in part on the first phase information and the first calibration coefficient; and
applying the second calibration coefficient to a first signal to be transmitted by the first network node to the WD.

12. The method of claim 11, wherein determining the second calibration coefficient is based at least in part on determining a difference between the first calibration coefficient and the first phase information.

13. The method of claim 11, wherein the second calibration coefficient calibrates a phase of the first signal relative to a phase of a second signal transmitted by the second network node to the WD.

14. The method of claim 11, further comprising transmitting a phase alignment request to the second network node, the phase alignment request including a pilot signal to carry the first phase information included in the phase alignment response.

15. The method of claim 14, wherein transmitting the phase alignment request is responsive to a phase alignment announcement received from the second network node.

16. A first network node configured to communicate with a wireless device, WD, the first network node comprising:
a radio interface configured to receive from a second network node a phase alignment response including first phase information and a first calibration coefficient; and
processing circuitry in communication with the radio interface and configured to:
determine a second calibration coefficient based at least in part on the first phase information and the first calibration coefficient; and
apply the second calibration coefficient to a first signal to be transmitted by the first network node to the WD.

17. The first network node of claim 16, wherein determining the second calibration coefficient is based at least in part on determining a difference between the first calibration coefficient and the first phase information.

18. The first network node of claim 16, wherein the second calibration coefficient calibrates a phase of the first signal relative to a phase of a second signal transmitted by the second network node to the WD.

19. The first network node of claim 16, wherein the radio interface is further configured to transmit a phase alignment request to the second network node, the phase alignment request including a pilot signal to carry the first phase information included in the phase alignment response.

20. The first network node of claim 19, wherein transmitting the phase alignment request is responsive to a phase alignment announcement received from the second network node.
